(19) United States
(12) Patent Application Publication
(10) Pub. No.: US 2004/0169979 A1
(43) Pub. Date: Sep. 2, 2004

(54) Over-current protection apparatus and method for a switching mode regulator

(76) Inventor: Chung-Lung Pai, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/704,615

(22) Filed: Nov. 12, 2003

(30) Foreign Application Priority Data
Nov. 14, 2002 (TW) 091133461

(51) Int. Cl. H02H 7/00; H02H 9/00

(52) U.S. Cl. 361/93.1; 361/18

(57) ABSTRACT

In a switching mode regulator including a pair of high-side and low-side switches in response to a control signal to turn on the high-side switch in on-duty cycles and the low-side switch in off-duty cycles to generate a current through an inductor and derive an output voltage that is sensed to generate a feedback signal to be compared with a first reference signal to thereby determine an error signal further compared with a second reference signal to generate the control signal, an over-current protection apparatus comprises a current sense circuit for sensing the inductor current in off-duty cycles. During soft start-up period, periodic force current sense interval is introduced for the inductor current to be sensed. When the inductor current exceeds threshold or the error signal lasts for several cycles at maximum value, the next on-duty cycle is blanked so as not to turn on the high-side switch.

### FIELD OF THE INVENTION

The present invention relates generally to a switching mode regulator, and more particularly, to an over-current protection apparatus and method for a switching mode regulator.

### BACKGROUND OF THE INVENTION

Current sense is used in switching mode regulators to provide protection of over-current or short circuit in high-voltage circuits thereof. On-duty current sense can achieve real-time current sense and response therefore. However, in some extreme cases, the on-duty cycle is too short to sense the operating current. For example, in a typical high-voltage DC-to-DC buck converter application, the input voltage from power supply has a level up to 28 V, while the converter output is regulated to 3.3 V and its operating frequency is about 200 KHz, and thus only 0.6 Ps is available for current sense. This period is extremely short, and appears even more insufficient under higher operating frequency operations. As a result, when the inductor current of the converter slowly increases, the operating current is likely to get out of control. Alternatively, this phenomenon does not occur when off-duty current sense is used. Yet, off-duty current sense does not reflect real-time circuit response, and thus has several drawbacks. For example, if the maximum on-duty is 90% and the switching frequency is 200 KHz, there is only 0.5 ps available for current sense when the on-duty cycle reaches its maximum value at soft start-up or heavy load transient. This duration is far too short and appears even more inadequate under higher frequency operations.

FIG. 8 shows a waveform diagram of the inductor current in a prior art regulator using off-duty current sense at soft start-up. During soft start-up period 74, inductor current 72 gradually rises. FIG. 9 shows an enlarged view illustrating a partial waveform 75 of the waveform 72. Soft start-up signal 76 is compared with a ramp signal 78 so as to determine control signal 80. When on-duty cycle 82 reaches the maximum value, there is no sufficient space for off-duty cycle to sense the inductor current 72. The problem can be solved with increased duration for current sense by reducing the on-duty cycles during soft start-up period. However, duration of the soft start-up is also inevitably lengthened.

### SUMMARY OF THE INVENTION

An object of the present invention is to provide a switching mode regulator that accomplishes over-current protection under high frequency operations.

Another object of the present invention is to provide a switching mode regulator with off-duty current sense, which accomplishes rapid soft start-up.

Yet another object of the present invention is to provide a switching mode regulator with off-duty current sense, which accomplishes protection of short circuit to regulator output during soft start-up period.

In a switching mode regulator, according to the present invention, a pair of high-side and low-side switches is employed in response to a control signal to turn on the high-side switch in on-duty cycles and to turn on the low-side switch in off-duty cycles, thereby producing a current through an inductor and deriving an output voltage through the inductor. The output voltage is sensed to generate a feedback signal to be compared with a first reference signal so as to determine an error signal, and the error signal is further compared with a second reference signal to generate the control signal. An over-current protection apparatus comprises a current sense circuit for sensing the inductor current of the regulator in the off-duty cycles. When the inductor current exceeds a threshold, the next on-duty cycle is blanked so as not to turn on the high-side switch. Furthermore, during the soft start-up period, a periodic force current sense interval is introduced for the inductor current to be sensed. In addition, when the error signal lasts for several cycles at its maximum value, the next on-duty cycle is also blanked so as not to turn on the high-side switch.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a circuit diagram of a switching mode regulator with over-current protection;

FIG. 2 shows a waveform diagram of the inductor current in the circuit shown in FIG. 1 at its soft start-up;

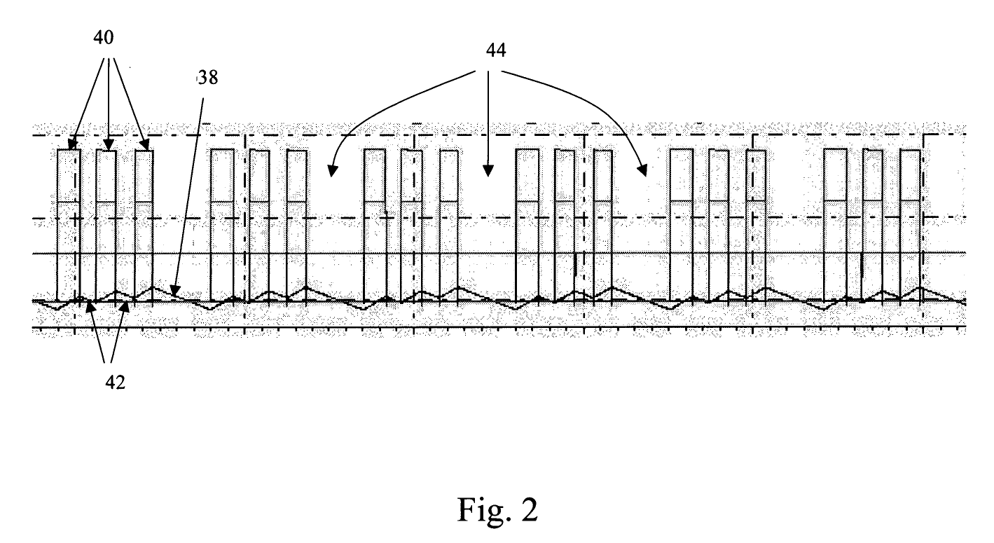

FIG. 3 shows a schematic view illustrating the over-current protection for the circuit shown in FIG. 1 at its soft start-up;

FIG. 4 shows a waveform diagram of the control signal of the circuit shown in FIG. 1 under normal operations;

FIG. 5 shows a waveform diagram illustrating the output voltage of the circuit shown in FIG. 1;

FIG. 6 shows a waveform diagram of various signals of the circuit shown in FIG. 1;

FIG. 7 shows a schematic view illustrating the over-current protection for the circuit shown in FIG. 1;

FIG. 8 shows a waveform diagram of the inductor current in a prior art regulator at soft start-up; and

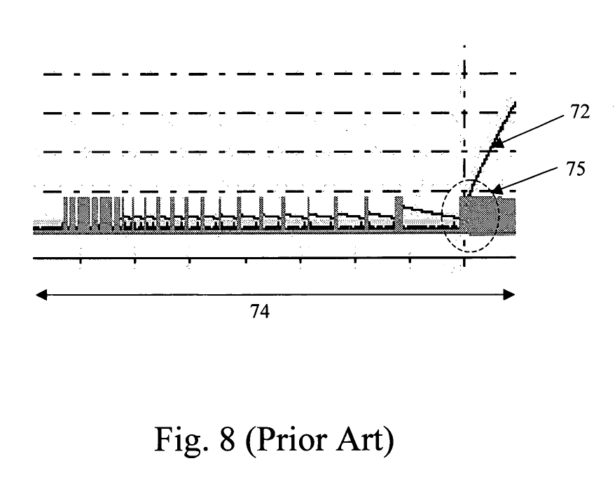

FIG. 9 shows a partial enlarged view illustrating the waveform diagram of the inductor current shown in FIG. 8.

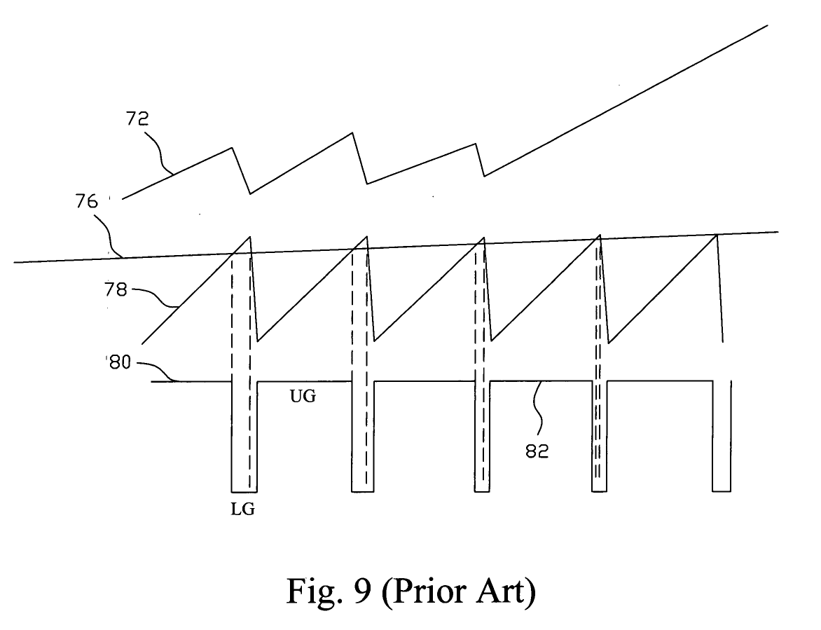

### DETAILED DESCRIPTION OF THE INVENTION

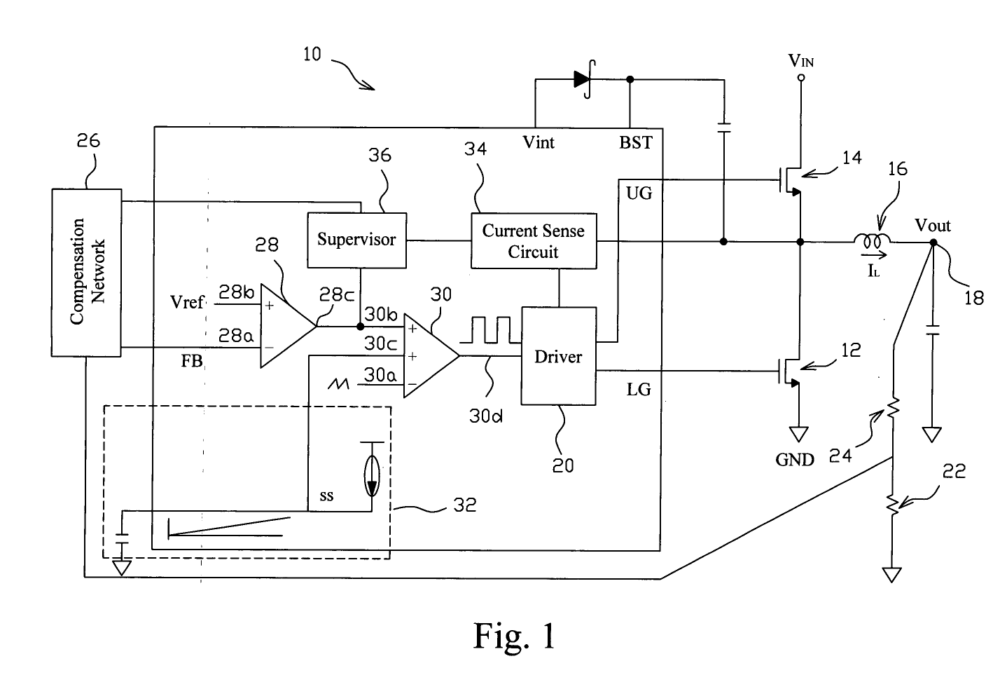

With reference to FIG. 1, a switching mode regulator 10 with over-current protection comprises a low-side NMOS transistor 12 and a high-side NMOS transistor 14, in which the low-side MNOS transistor 12 has a drain connected to ground GND and a source connected to a regulator output 18 through an inductor 16, and the high-side NMOS transistor 14 has a source also connected to the output 18 through the inductor 16 and a drain connected to an input voltage VIN from a power supply (not shown). The low-side NMOS transistor 12 and the high-side NMOS transistor 14 each has a gate connected to two outputs LG and UG of a driver 20, respectively. The driver 20 turns on the high-side NMOS transistor 14 in the on-duty cycles and turns on the low-side NMOS transistor 12 in the off-duty cycles, so as to produce an inductor current I_{L} that passes through the inductor 16, and an output voltage V_{OUT} at the regulator output 18. The output voltage V_{OUT} is sensed by a voltage divider including resistors 22 and 24 and by passing through a compensation network 26 to produce a feedback signal FB. In other words, the output voltage V_{OUT} is sensed to produce the feedback signal FB. An error amplifier 28 has an inverted input 28a connected to the feedback signal FB and a non-inverted input 28b connected to a reference voltage V_{ref}. The error amplifier 28 compares the feedback signal FB with the reference voltage V_{ref} to produce an error signal 28c. A pulse-width modulation (PWM) comparator 30 has an inverted input 30a connected to a ramp signal, a non-inverted input 30b connected to the error signal 28c, and the other non-inverted input 30c connected to a soft start-up signal SS provided by a soft start-up apparatus 32. In normal operations, the PWM comparator 30 compares the ramp signal 30a with the error signal 30b and produces a PWM signal at an output 30d to the driver 20. During the soft start-up period, the soft start-up apparatus 32 produces the soft start-up signal SS for the PWM comparator 30 to modulate the PWM signal 30d. An over-current protection apparatus includes a current sense circuit 34 connected to the drain of the low-side NMOS transistor 12 to sense the inductor current I_{L}, and to the driver 20 to control the manipulation of the driver 20, and a supervisor 36 connected to the compensation network 26 and with the error signal 28c to monitor the error signal, and to affect the driver 20 via the current sense circuit 34.

FIG. 1 shows a waveform diagram of the inductor current in the circuit shown in FIG. 1 at soft start-up. Apart from the control signal to alternatively switch the high-side and low-side NMOS transistors 14 and 12 between on-duty cycles 40 and off-duty cycles 42, a periodic force current sense interval 44 is further introduced to increase extra time for current sense thereof. The periodic force current sense interval 44 forces blanking an on-duty cycle 40 after a certain number of on-duty cycles 40. This additional interval 44 is included in 30d.

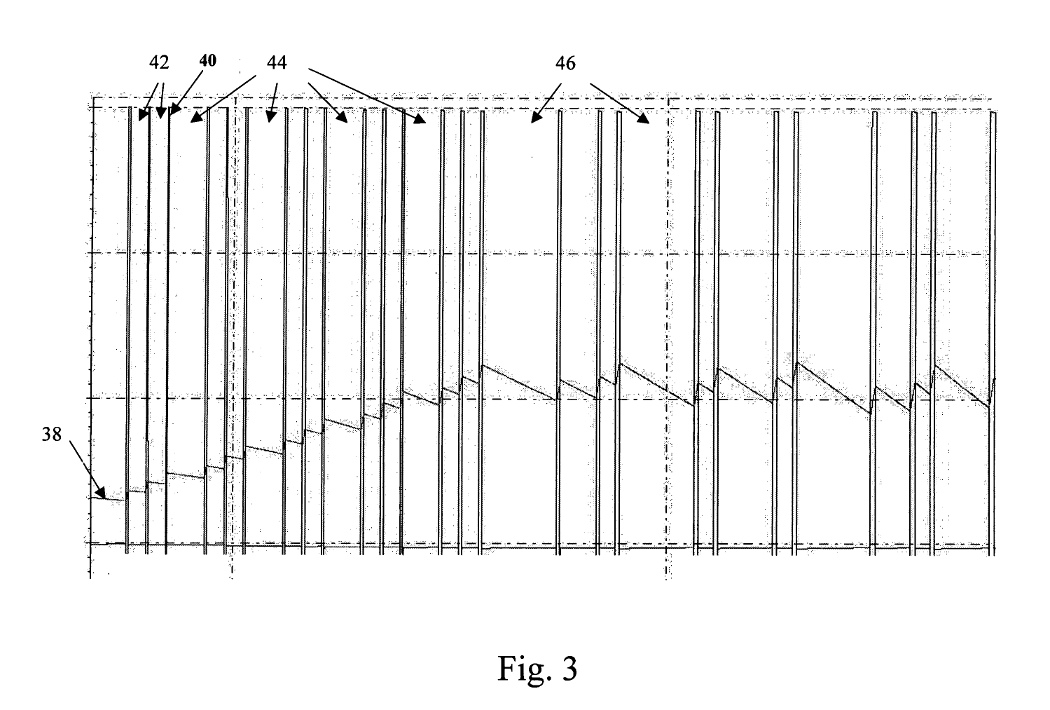

FIG. 3 also shows a waveform 38 of the inductor current I_{L} at soft start-up. In addition to the periodic force current sense interval 33 inserted after every three on-duty cycles 40, the next on-duty cycle is blanked for example as the blank interval 46 once the inductor current 38 exceeding a threshold, in which there is included a periodic force current sense interval and a blanked on-duty cycle for over-current protection.

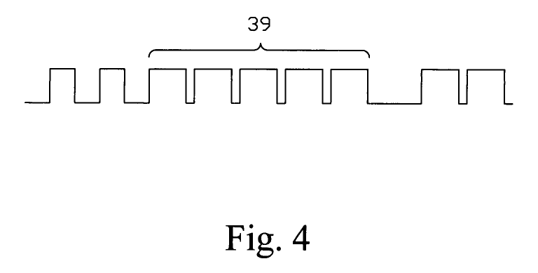

FIG. 4 shows the control signal during normal operations. When the supervisor 36 detects the error signal 28c staying at a maximum value for five cycles 39, it affects the driver 20 by the current sense circuit 34 to blank the next on-duty cycle.

When the inductor current I_{L} is detected to be over-current during soft start-up period and normal operations, the next on-duty cycle is blanked. The current sense circuit 34 detects the inductor current I_{L} in the off-duty cycles, and when the inductor current I_{L} exceeds the threshold, the current sense circuit 34 affects the driver 20 to blank the next on-duty cycle.

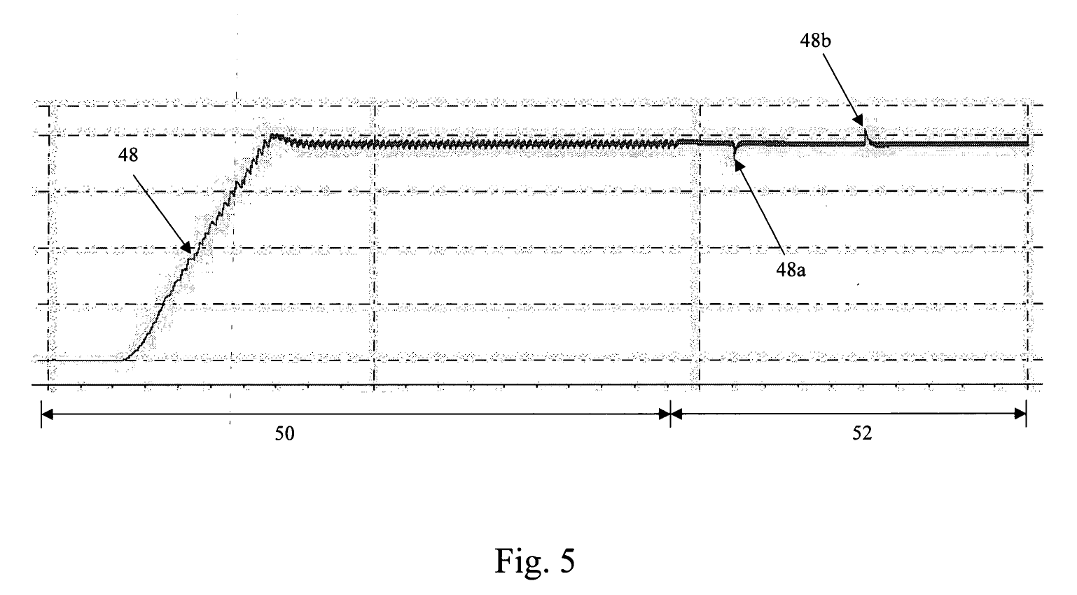

FIG. 5 shows a waveform 48 of the output voltage V_{OUT}. During soft start-up period, ripples occur in the output voltage V_{OUT} resulted from reduction of the inductor current I_{L} due to periodic force current sense intervals. During normal operation period 52, surges 48a and 48b are formed because of instantaneous rising and falling of the inductor current I_{L} under heavy loading.

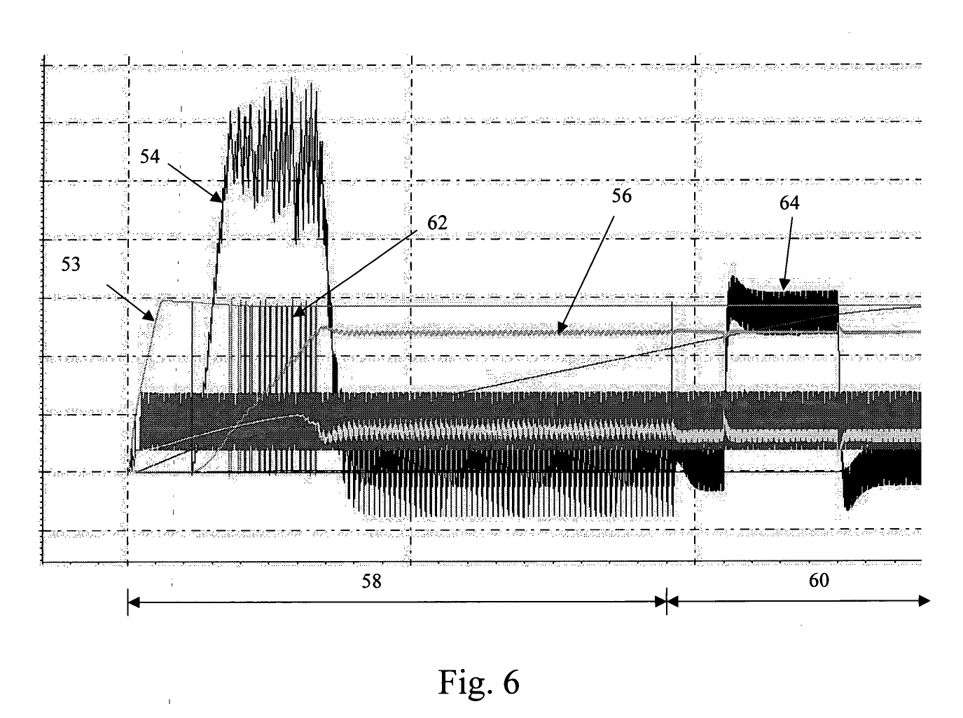

FIG. 6 shows the waveforms of various signals of the circuit shown in FIG. 1. Waveform 53 is the input voltage V_{IN}, and waveform 54 is the inductor current I_{L} at the large current waveform when the output voltage V_{OUT} rises rapidly during soft start-up period 58. During this period, the inductor current I_{L} exceeds the threshold, as shown by a waveform 62. During the soft start-up period 58, the periodic force current sense intervals cause ripples 56 on the output voltage V_{OUT}. In the normal operations 60, a surge 64 is incurred by the inductor current I_{L} undergoing instantaneous load change.

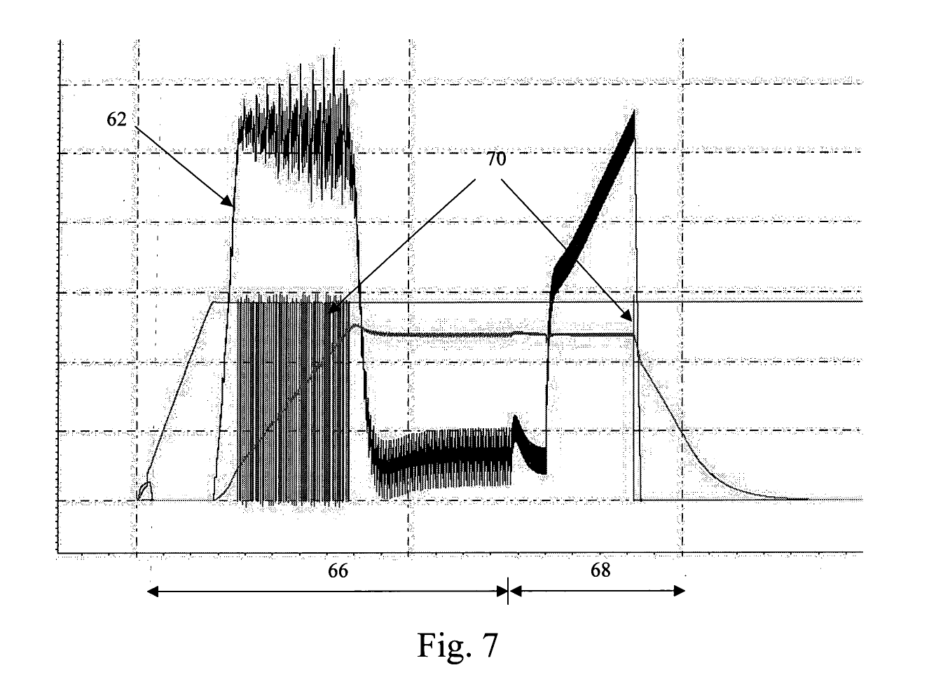

FIG. 7 shows waveforms under conditions of a frequency of 424 KHz, a soft start capacitance of 3 nF, an input voltage of 24V and an output voltage of 5V. During soft start 66 or a normal operation interval 68, a current sense signal 70 has the driver 20 blank a next on-duty cycle when the inductor current I_{L} exceeds the threshold.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. An over-current protection apparatus for a switching mode regulator having a pair of a high-side switch and a low-side switch responsive to a control signal to turn on the high-side switch in on-duty cycles and to turn on the low-side switch in off-duty cycles for producing a current through an inductor and deriving an output voltage through the inductor, the output voltage being sensed for generating a feedback signal compared with a first reference signal to thereby determine an error signal to be further compared with a second reference signal for generating the control signal, the over-current protection apparatus comprising:
a current sense circuit for sensing the inductor current in the off-duty cycles;
wherein a next on-duty cycle is blanked so as not to turn on the high-side switch when the inductor current exceeding a threshold.

2. The over-current protection apparatus of claim 1, further comprising a soft start-up circuit for generating a soft start-up signal during a soft start-up period to introduce a periodic force current sense interval for the current sense circuit to sense the inductor current.

3. The over-current protection apparatus of claim 1, further comprising a supervisor for monitoring the error signal during a normal operation period, wherein the next on-duty cycle is blanked so as not to turn on the high-side switch when the error signal lasts at a maximum value for a plurality of cycles.

4. An over-current protection method for a switching mode regulator having a pair of a high-side switch and a low-side switch responsive to a control signal to turn on the high-side switch in on-duty cycles and to turn on the low-side switch in off-duty cycles for producing a current through an inductor and deriving an output voltage through the inductor, the output voltage being sensed for generating a feedback signal compared with a first reference signal to thereby determine an error signal to be further compared with a second reference signal for generating the control signal, the over-current protection method comprising the steps of:
sensing the inductor current in the off-duty cycles; and
blanking a next on-duty cycle so as not to turn on the high-side switch when the inductor current exceeding a threshold.

5. The over-current protection method of claim 4, further comprising the steps of:
introducing a periodic force current sense interval during a soft start-up period; and
sensing the inductor current during the periodic force current sense interval.

6. The over-current protection method of claim 4, further comprising the steps of:
monitoring the error signal during a normal operation period; and
blanking a next on-duty cycle so as not to turn on the high-side switch when the error signal lasts at a maximum value for a plurality of cycles.

7. A switching mode regulator with an over-current protection, comprising:
a pair of a high-side switch and a low-side switch connected by a common output node;
an inductor connected between the common output node and a regulator output;
a PWM comparator for comparing an error signal with a ramp signal to thereby generate a control signal having on-duty cycles and off-duty cycles;
a driver for generating a first driving signal to turn on the high-side switch in the on-duty cycles and a second driving signal to turn on the low-side switch in the off-duty cycles, to thereby generate a current through the inductor and derive an output voltage at the regulator output;
a voltage sense circuit for sensing the output voltage to thereby generate a feedback signal;
an error amplifier for comparing the feedback signal with a first reference signal to thereby determine an error signal; and
a current sense circuit for sensing the inductor current in the off-duty cycles, wherein a next on-duty cycle is blanked when the inductor current exceeding a threshold.

8. The switching mode regulator of claim 7, wherein the current sense circuit senses a current flowing through the low-side switch.

9. The switching mode regulator of claim 8, wherein the current sense circuit is connected to the common output node.

10. The switching mode regulator of claim 7, further comprising a soft start-up circuit for generating a soft start-up signal during a soft start-up period to introduce a periodic force current sense interval for the current sense circuit to sense the inductor current during the periodic force current sense interval.

11. The switching mode regulator of claim 10, wherein the soft start-up circuit is connected to the PWM comparator for introducing the periodic force current sense interval to the control signal.

12. The switching mode regulator of claim 10, wherein the soft start-up circuit is connected to the driver for introducing the periodic force current sense interval to the first driving signal.

13. The switching mode regulator of claim 7, further comprising a supervisor for monitoring the error signal during a normal operation period, wherein a next on-duty cycle is blanked when the error signal lasts at a maximum value for a plurality of cycles.

14. A method for generating a regulator voltage, comprising the steps of:
connecting a pair of a high-side switch and a low-side switch by a common output node therebetween;
connecting an inductor between the common output node and a regulator output;
comparing an error signal with a ramp signal for generating a control signal having on-duty cycles and off-duty cycles;
generating a first driving signal for turning on the high-side switch in the on-duty cycles and a second driving signal for turning on the low-side switch in the off-duty cycles to thereby produce a current flowing through the inductor and derive the regulator voltage at the regulator output;
sensing the regulator voltage for generating a feedback signal;
comparing the feedback signal with a reference signal for determining the error signal;
sensing the inductor current for generating a current sense signal in the off-duty cycles; and
blanking a next on-duty cycle when the current sense signal exceeding a threshold.

15. The method of claim 14, wherein the step of sensing the inductor current comprises the steps of:
sensing a current flowing through the low-side switch; and
generating the current sense signal in response to the current flowing through the low-side switch.

16. The method of claim 14, further comprising the steps of:
introducing a periodic force current sense interval during a soft start-up period; and
sensing the inductor current during the periodic force current sense interval.

17. The method of claim 16, wherein the periodic force current sense interval is introduced to the control signal.

18. The method of claim 16, wherein the periodic force current sense interval is introduced to the first driving signal.

19. The method of claim 16, further comprising the steps of:
monitoring the error signal during a normal operation period; and
blanking the next on-duty cycle when the error signal continuously stays at a maximum value for a plurality of cycles.
